(19) United States
(12) Patent Application Publication
(10) Pub. No.: US 2020/0245146 A1
(43) Pub. Date: Jul. 30, 2020

(54) METHOD AND A DEVICE FOR PERFORMING WIRELESS CONNECTION PRE-AUTHORIZATION ON A USER DEVICE

(71) Applicant: Shanghai Zhangmen Science and Technology Co., Ltd., Shanghai (CN)

(72) Inventor: Han CHENG, Shanghai (CN)

(21) Appl. No.: 16/796,965

(22) Filed: Feb. 21, 2020

Related U.S. Application Data
(63) Continuation of application No. PCT/CN2018/099343, filed on Aug. 8, 2018.

(30) Foreign Application Priority Data
Aug. 21, 2017 (CN) 201710720676.1

(51) Int. Cl. H04W 12/06; H04W 12/00; H04W 76/10; H04W 64/00

(52) U.S. Cl. CPC H04W 12/0602; H04W 64/00; H04W 76/10; H04W 12/009

(57) ABSTRACT

The present application provides a method and a device for performing wireless connection pre-authorization on a user device. In the present application, a network device determines a target wireless access point to be accessed by the user device of a user according to activity information of the user, and transmits device identification information of the user device to a wireless routing device corresponding to the target wireless access point; the wireless routing device performs wireless connection pre-authorization on the user device based on the device identification information after receiving the device identification information of the user device; since the user device of the user has been pre-authorized, the user subsequently connects to a wireless access point corresponding to the wireless routing device by the user device without the need for an authorization process. Therefore, the user is released from tedious operations, the time for establishing connection is reduced.

### CROSS REFERENCE TO THE RELATED APPLICATION

This application is the continuation application of International Application No. PCT/CN2018/099343, filed on Aug. 8, 2018, which is based upon and claims priority to Chinese Patent Application No. 201710720676.1, filed on Aug. 21, 2017, the entire contents of which are incorporated herein by reference.

### FIELD

The present application relates to communication, and more particularly relates to a technology for performing wireless connection pre-authorization on a user device.

### BACKGROUND

With the popularity of mobile devices and the development of the Internet, people increasingly rely on wireless networks in their daily lives. Public wireless networks have low security. People usually choose to perform connection authentication encryption on wireless networks to restrict unauthorized users from accessing the wireless network, to ensure the security.

When a mobile device connects to an encrypted wireless network, cooperation with a routing device is often required. However, a traditional router's authentication and authorization method is passive, and the hotspot owner often needs to provide an authentication password to the user who requests connection. Wireless connections can be available only when the authorization is completed after the authentication is passed in some way. In this process, the authentication and authorization process is in serial with the process of the user using the network. The user's operation is thus tedious, time-consuming, and the time for authorization is long, resulting in a poor user experience.

### SUMMARY

One embodiment of the present application to provide a method and a device for performing wireless connection pre-authentication on a user device.

According to an aspect of the present application, it is provided a method for performing wireless connection pre-authorization on a user device at a network device. The method comprises:

determining a target wireless access point to be accessed by the user device of a user according to activity information of the user;

transmitting device identification information of the user device to a wireless routing device corresponding to the target wireless access point for the wireless routing device to perform wireless connection pre-authorization on the user device.

According to another aspect of the present application, it is provided a method for performing wireless connection pre-authorization on a user device at a wireless routing device. The method comprises:

acquiring device identification information of the user device transmitted by a network device;

performing wireless connection pre-authorization on the device identification information.

According to a further aspect of the present application, it is provided a method for performing wireless connection pre-authorization on a user device. The method comprises:

determining, by a network device, a target wireless access point to be accessed by the user device of a user according to activity information of the user;

transmitting, by the network device, device identification information of the user device to a wireless routing device corresponding to the target wireless access point for the wireless routing device to perform wireless connection pre-authorization on the user device;

acquiring, by the wireless routing device, the device identification information of the user device transmitted by the network device;

performing, by the wireless routing device, wireless connection pre-authorization on the device identification information.

According to yet another aspect of the application, a computer readable medium comprising instructions is provided, and the instructions, when executed, cause a system to perform the operations of the above mentioned methods.

According to a further aspect of the present application, it is provided a network device for performing wireless connection pre-authorization on a user device. The network device comprises:

a processor; and

a memory configured to store computer executable instructions, and the executable instructions, when executed, cause the processor to perform the above mentioned methods.

According to a further aspect of the present application, it is provided a wireless routing device for performing wireless connection pre-authorization on a user device. The wireless routing device comprises:

a processor; and

a memory configured to store computer executable instructions, and the executable instructions, when executed, cause the processor to perform the above mentioned methods.

Compared with the prior art, in the present application, a network device determines a target wireless access point to be accessed by the user device of a user according to activity information of the user, and transmits device identification information of the user device to a wireless routing device corresponding to the target wireless access point; the wireless routing device performs wireless connection pre-authorization on the user device based on the device identification information after receiving the device identification information of the user device; since the user device of the user has been pre-authorized, the user subsequently connects to a wireless access point corresponding to the wireless routing device by the user device without the need for an authorization process. Therefore, the user is released from tedious operations, the time for establishing connection is reduced, and user experience is optimized. Further, the activity information of the user may include historic activity information of the user, current location information, etc. In this way, the network device can determine a target wireless access point to be accessed by the user device of the user more intelligently, thus providing wireless connection service with better quality to the user and improve user experience.

### DESCRIPTIONS OF THE DRAWINGS

Embodiments of the present application will become more apparent by reading the detailed description of non-limiting embodiments with reference to the following drawings:

FIG. 1 shows a topology diagram of a system for performing wireless connection pre-authorization on a user device according to an embodiment of the present application;

FIG. 2 shows a flowchart of a method for performing wireless connection pre-authorization on a user device according to another embodiment of the present application;

FIG. 3 shows a flowchart of a method for performing connection authentication on a user device by a wireless routing device according to a further embodiment of the present application.

The identical or similar reference numerals in the drawings represent the identical or similar components.

### DETAILED EMBODIMENTS

The application is further described in detail below with reference to the accompanying drawings.

In a typical configuration of the present application, a terminal, a device of a service network and a trusted party all include one or more processors (CPUs), an input/output interface, a network interface and a memory.

The memory may include a non-permanent memory, a random access memory (RAM) and/or a non-volatile memory and the like in a computer-readable medium, such as a read-only memory (ROM) or a flash memory (flash RAM)). A memory is an example of a computer-readable medium.

A computer-readable medium comprises permanent and non-permanent, movable and non-movable media and may implement information storage by means of any method or technology. Information may be computer-readable instructions, data structures, program modules or other data. The examples of a computer storage medium include but are not limited to a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, compact disk read-only memory (CD-ROM), a digital versatile disc (DVD) or other optical storages, a magnetic cassette tape, and magnetic tape and magnetic disk storage or other magnetic storage devices or any other non-transmission media, which can be used to store information that can be accessed by a computing device.

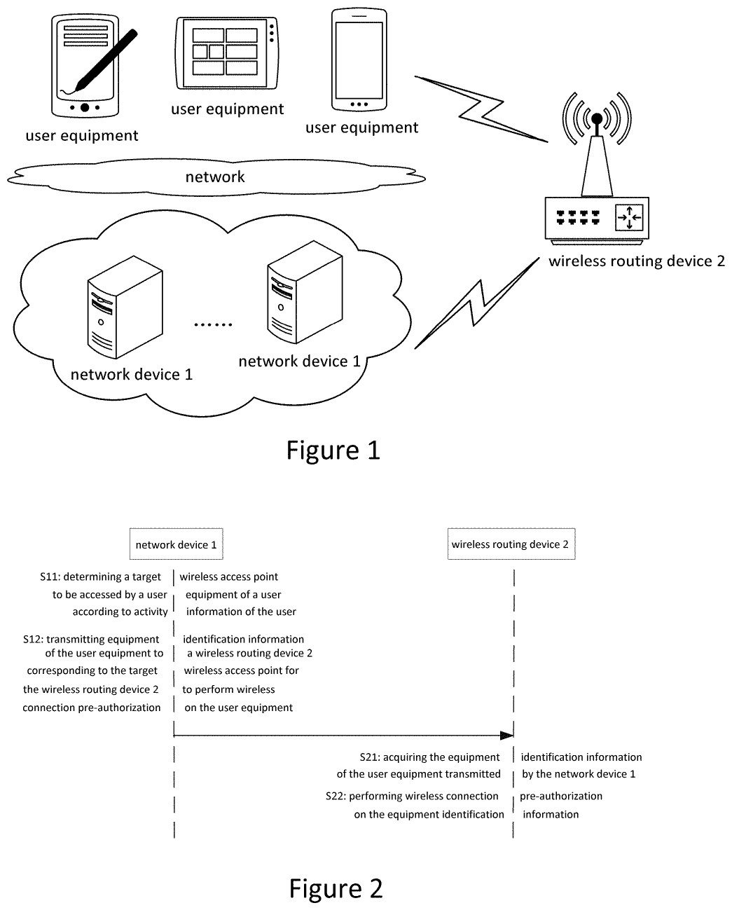

FIG. 1 shows a topology diagram of a system for performing wireless connection pre-authorization on a user device according to an embodiment of the present application. The system comprises a network device 1, a wireless routing device 2 and a user device.

Here, the network device 1 includes an electronic device to automatically perform numeral calculations and information processing according to preset or stored instructions. It's hardware includes but is not limited to micro-processors, application specific integrated circuits (ASIC), programmable gate array (FPGA), digital signal processors (DSP), embedded devices, etc. The network device 1 includes but is not limited to: computers, mainframes, single network server, a cloud composed of multiple network server sets or multiple servers. Cloud as used herein is formed by a massive amount of computers or network servers based on cloud computing, and cloud computing is a type of distributed computing, which is a virtual super computer composed of a group of loosely coupled computer sets. Networks include but are not limited to internet, Wide Area Network (WAN), Metropolitan Area Network (MAN), Local Area Network (LAN), Virtual Private Network (VPN), wireless ad-hoc network, etc. The wireless routing device 2 includes a device to connect various local area networks, wide area networks. In one embodiment, the wireless routing device 2 is to broadcast wireless access points to user devices within a range based on a protocol cluster of 802.11. In one embodiment, the authentication type of the wireless routing device 2 is a non-open system authentication. The user device includes but is not limited to any type of electronic product with human-machine interaction with the users, for example, a smart phone, a tablet, a laptop, etc. The electronic products can run on any operating system, such as android operating system, iOS operating system, Windows operating system, etc.

In some embodiment, the number of various network elements shown in FIG. 1 for the sake of brevity might be smaller than the number in practical networks. This omission is undoubtedly based on the premise that it will not affect the clear and sufficient disclosure of the present disclosure.

FIG. 2 shows a flowchart of a method for performing wireless connection pre-authorization on a user device according to another embodiment of the present application. The method comprises step S11 and step S12 performed at a network device and step S21 and step S22 performed at a wireless routing device.

In one embodiment, at step S11, the network device 1 determines a target wireless access point to be accessed by the user device of a user according to activity information of the user. At step S12, the network device 1 transmits device identification information of the user device to a wireless routing device 2 corresponding to the target wireless access point for the wireless routing device 2 to perform wireless connection pre-authorization on the user device. At step S21, the wireless routing device 2 acquires the device identification information of the user device transmitted by the network device 1. At step S22, the wireless routing device 2 performs wireless connection pre-authorization on the device identification information.

In an example, the activity information of the user is assumed to include: user B is located at Building B during 9:00 to 17:00 on weekdays and is located at a residential area C from 18:00 to 8:00 the next day. Assume it is 8:45 weekday now. With bid data analysis technology, the network device 1 can determine that a target wireless access point to be accessed by the user device (such as an intelligent phone) carried by user B is the wireless access point at place B according to the activity information of the user. The network device 1 then transmits device identification information of the user device of user B to the wireless routing device (such as the wireless routing device 2) at place B. The device identification information includes but is not limited to: MAC address information, equipment sequence number information, Bluetooth identification information, user account information, phone number information, and the like. The wireless routing device at place B then performs wireless connection pre-authorization on the user device of user B based on the device identification information. When user B arrives at place B later, the user device of user B can connect to the wireless access point at place B without the need for authorization since it has been pre-authorized, thus optimizing the user's wireless connection experience.

In one embodiment, the activity information of the user includes at least one of: historic activity information of the user; current location information of the user.

In an embodiment, a wireless routing device corresponding to a wireless access point generally has a fixed geographic location. A user device is able to connect to the corresponding wireless access point within a range of the wireless routing device. If the user device carried by the user is connected to a wireless access point W at time T, the area to which the wireless access point W belonged is determined as activity area of the user at time T. The network device 1 thus can determine the historic activity information of the user according to the connection records information of the user connecting to wireless access points. The network device 1 can also determine the current location information of the user according to the wireless access point currently connected by the user. In other embodiments, the network device 1 can also determine the historic activity information of the user according to the purchase records information of the user. Or the network device 1 can also acquire GPS coordinates information uploaded by the user device at different periods of time to determine the historic activity information of the corresponding user. The network device 1 can also acquire the GPS coordinate information currently uploaded by the user device to determine the current location information of the corresponding user.

In one embodiment, the method further comprises: the network device 1 determines pre-authorization information for the device identification information of the user device with respect to the wireless routing device corresponding to the target wireless access point. At step S12, the network device 1 transmits the device identification information and the pre-authorization information to the wireless routing device 2 for the wireless routing device 2 to perform wireless connection pre-authorization on the user device. At step S21, the wireless routing device 2 receives the device identification information of the user device and the pre-authorization information for the device identification information with respect to the wireless routing device 2 transmitted by the network device 1. At step S22, if the pre-authorization information comprises a successful pre-authorization, the wireless routing device 2 performs wireless connection pre-authorization on the device identification information.

In an example, the network device 1 can query and determine whether the user device has been pre-authorized to connect to the wireless routing device corresponding to the target wireless access point based on the device identification information of the user device, and acquire the pre-authorization information (for example, including indications of successful pre-authorization, failed pre-authorization, or no need for duplicate authorization). After the wireless routing device 2 receives the pre-authorization information and the device identification information of the user device transmitted by the network device 1, if the pre-authorization information comprises a successful pre-authorization, the wireless routing device 2 performs wireless connection pre-authorization on the device identification information of the user device. Correspondingly, if the pre-authorization information comprises a failed pre-authorization or indicates that there is no need for duplicate authorization, the wireless routing device 2 does not have to perform wireless connection pre-authorization on the device identification information of the user device.

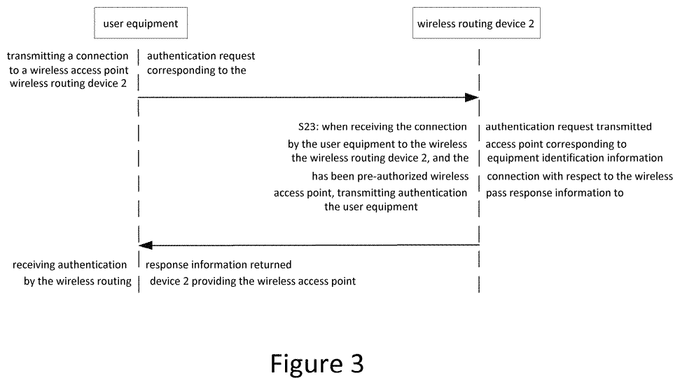

In one embodiment, as illustrated in FIG. 3, the method further comprises step S23 performed at the wireless routing device. At step S23, when the wireless routing device 2 receives the connection authentication request transmitted by the user device to the wireless access point corresponding to the wireless routing device 2, and the device identification information has been pre-authorized wireless connection with respect to the wireless access point, the wireless routing device 2 transmits authentication pass response information to the user device.

In an example, assuming that user A arrives at somewhere proximate the wireless routing device 2, the user device can automatically transmit a connection authentication request to the wireless access point corresponding to the wireless routing device 2, or the user device can transmit the connection authentication request to the wireless access point corresponding to the wireless routing device 2 based on user A's manual operation. The wireless routing device 2 determines whether the user device has been pre-authorized based on the device identification information of the user device after receiving the connection authentication request. If the device identification information of the user device has been pre-authorized wireless connection with respect to the wireless access point, the wireless routing device 2 returns authentication pass response information to the user device. The user device can connect to the wireless access point corresponding to the wireless routing device 2 successfully.

In one embodiment, after establishing wireless connection between the user device and the wireless routing device 2 (the user device cannot access networks through the wireless routing device 2 at this moment), the user device transmits its corresponding device identification information to the wireless routing device 2 for verification over the wireless connection. If the device identification information transmitted by the user device is consistent with the device identification information previously transmitted by the network device 1, the wireless routing device 2 permits network access for the user device.

In one embodiment, step S23 further comprises: if the device identification information has not been pre-authorized wireless connection with respect to the wireless access point, the wireless routing device 2 performs authentication on the connection authentication request and transmits corresponding authentication result information to the user device.

In the embodiment, the wireless routing device 2 determines whether the user device has been pre-authorized based on the device identification information of the user device after receiving the connection authentication request transmitted by the user device. If the device identification information of the user device has not been pre-authorized wireless connection with respect to the wireless access point, the wireless routing device 2 cannot directly return authentication pass response information to the user device. The wireless routing device 2 has to perform normal authentication on the connection authentication request, and then transmits corresponding authentication result information to the user device (e.g., including a successful authentication or a failed authentication).

In one embodiment, the activity information of the user includes historic activity information of the user. At step S11, the network device 1 determines future activity location information of the user according to the historic activity information of the user, and determines a target wireless access point to be accessed by the user device of the user according to the future activity location information.

In an example, the historic activity information of user B is assumed to include: user B is located at Building B during 9:00 to 17:00 on weekdays and is located at a residential area C from 18:00 to 8:00 the next day. Assume it is 8:45 weekday now. With big data analysis technology, the network device 1 can determine that the future activity location information of user B includes place B according to the historic activity information of user B, and determine that the target wireless access point to be accessed by the user device (such as a smart phone) carried by user B is the wireless access point at place B according to the future activity location information.

In one embodiment, at step S11, the network device 1 determines future activity location information of the user in future period of time information according to the historic activity information of the user, and determines a target wireless access point to be accessed by the user device of the user in the future period of time information according to the future activity location information. In one embodiment, the target wireless access point is located from the future activity location information at a distance which is less than or equals to distance threshold information. At step S12, the network device 1 transmits device identification information of the user device and the future period of time information to a wireless routing device 2 corresponding to the target wireless access point for the wireless routing device 2 to perform wireless connection pre-authorization on the user device. At step S21, the wireless routing device 2 acquires the device identification information and the corresponding future period of time information of the user device transmitted by the network device 1. At step S22, the wireless routing device 2 performs wireless connection pre-authorization on the device identification information based on the future period of time information.

In an example, the historic activity information of user C is assumed to include: user C is located at a cinema D during 15:00 to 17:00 every Saturday. With big data analysis technology, the network device 1 can determine the future activity location information (such as place D) of the future period of time information (such as 15:00 to 17:00 next Saturday) of user C according to the historic activity information of user C. The network device 1 determines a target wireless access point (such as a wireless access point located from D at a distance which is less than or equals to 30 meters) to be accessed by the user device of user C in the future period of time information (such as 15:00 to 17:00 next Saturday) according to the future activity location information (such as place D). The wireless routing device 2 at place D performs wireless connection pre-authorization on the device identification information of the user device based on the future period of time information after receiving the device identification information of the user device and the future period of time information transmitted by the network device 1. In an example, the wireless routing device 2 at place D pre-authorizes wireless connection to the user device of user C for a time period of 15:00 to 17:00 next Saturday.

In one embodiment, the method further comprises: when receiving a connection authentication request transmitted by the user device to a wireless access point corresponding to the wireless routing device 2, and the connection authentication request is transmitted within the future period of time information, and the device identification information has been pre-authorized wireless connection with respect to the wireless access point, the wireless routing device 2 transmitting authentication pass response information to the user device.

Continued with the above example, assume it is 15:03 Saturday now. When the wireless routing device 2 at place D receives a connection authentication request transmitted by the user device of user C, since the user device of user C has been pre-authorized and the current time is within the future period of time information, the wireless routing device 2 transmits authentication pass response information to the user device of user C.

In one embodiment, the activity information of the user includes current location information of the user. At step S11, the network device 1 determines a target wireless access point to be accessed by the user device of the user according to the current location information of the user, and the target wireless access point is located from the current location information at a distance which is less than or equals to distance threshold information.

In an example, the current location information of user D is supposed to include: the current GPS coordinate of the user device (such as a smart phone) of user D is at a coffee shop. The network device 1 can determine that a target wireless access point to be accessed by the user device of user D includes wireless access points proximate the coffee shop according to the current location information of user D. In an example, the network device 1 can determine a wireless access point located from the coffee shop at a distance which is less than or equals to 50 meters as the target wireless access point.

According to yet a further aspect of the present application, it is provided a method for performing wireless connection pre-authorization on a user device. The method comprises:

determining, by a network device, a target wireless access point to be accessed by the user device of a user according to activity information of the user;

transmitting, by the network device, device identification information of the user device to a wireless routing device corresponding to the target wireless access point for the wireless routing device to perform wireless connection pre-authorization on the user device;

acquiring, by the wireless routing device, the device identification information of the user device transmitted by the network device;

performing, by the wireless routing device, wireless connection pre-authorization on the device identification information.

According to yet another aspect of the application, a computer readable medium comprising instructions is provided, and the instructions, when executed, cause a system to perform the operations of the above mentioned methods.

According to a further aspect of the present application, it is provided a network device for performing wireless connection pre-authorization on a user device. The network device comprises:

a processor; and

a memory configured to store computer executable instructions, and the executable instructions, when executed, cause the processor to perform the above mentioned methods.

According to a further aspect of the present application, it is provided a wireless routing device for performing wireless connection pre-authorization on a user device. The wireless routing device comprises:

a processor; and

a memory configured to store computer executable instructions, and the executable instructions, when executed, cause the processor to perform the above mentioned methods.

Compared with the prior art, in the present application, a network device determines a target wireless access point to be accessed by the user device of a user according to activity information of the user, and transmits device identification information of the user device to a wireless routing device corresponding to the target wireless access point; the wireless routing device performs wireless connection pre-authorization on the user device based on the device identification information after receiving the device identification information of the user device; since the user device of the user has been pre-authorized, the user subsequently connects to a wireless access point corresponding to the wireless routing device by the user device without the need for an authorization process. Therefore, the user is released from tedious operations, the time for establishing connection is reduced, and user experience is optimized. Further, the activity information of the user may include historic activity information of the user, current location information, etc. In this way, the network device can determine a target wireless access point to be accessed by the user device of the user more intelligently, thus providing wireless connection service with better quality to the user and improve user experience.

It should be noted that the present application can be implemented in software and/or a combination of software and hardware, for example, by using an application specific integrated circuit (ASIC), a general purpose computer, or any other similar hardware device. In one embodiment, the software program of the present application can be executed by a processor to implement the steps or functions described above. Likewise, the software programs (including related data structures) of the present application can be stored in a computer readable storage medium such as a RAM memory, a magnetic or optical drive or a floppy disk and the like. In addition, some of the steps or functions of the present application may be implemented in hardware, for example, as a circuit that cooperates with a processor to perform various steps or functions.

In addition, a portion of the present application can be embodied as a computer program product, such as computer program instructions, when executed by a computer, can invoke or provide a method in accordance with the present application. In some embodiments, computer program instructions exist in a computer-readable medium in a form of including, but not limited to, a source file, an executable file, an installation package file, and the like. Correspondingly, the manner in which a computer program instruction is executed by a computer includes, but is not limited to, the computer directly executing the instruction, or the computer compiling the instruction and then executing the corresponding compiled program, or the computer reading and executing the instruction, or the computer reading and installing the instruction and then executing the corresponding post-installation program. Here, the computer-readable medium can be any available computer-readable storage medium or communication medium that can be accessed by a computer.

Communication medium includes medium by which communication signals which include, for example, computer-readable instructions, data structures, program modules, or other data, are transmitted from one system to another. Communication medium can include guided transmission medium (such as cables and wires (e.g., fiber optics, coaxial, etc.)) and wireless (non-conductive transmission) medium that can propagate energy waves, such as sound, electromagnetic, RF, microwave, and infrared. Computer readable instructions, data structures, program modules or other data may be embodied, for example, as a modulated data signal in a wireless medium, such as a carrier wave or a similar mechanism such as being embodied as part of a spread spectrum technology. The term “modulated data signal” refers to a signal whose one or more characteristics are altered or set by encoding information in the signal. Modulation can be analog, digital, or can be hybrid modulation techniques.

By way of example and not limitation, computer-readable storage medium may include volatile and non-volatile, removable and non-removable medium implemented by any method or technology used to store information such as computer readable instructions, data structures, program modules or other data. For example, computer-readable storage medium includes, but is not limited to, volatile memory such as random access memory (RAM, DRAM, SRAM); and non-volatile memory such as flash memory, various read-only memories (ROM, PROM, EPROM, EEPROM), magnetic and ferromagnetic/ferroelectric memory (MRAM, FeRAM); and magnetic and optical storage devices (hard disk, cassette, CD, DVD); or other existing or known medium or any medium to be developed in the future that can store computer-readable information/data for use by computer systems.

In some embodiments, it is apparent that the present application is not limited to the details of the above-mentioned exemplary embodiments, and the present application can be implemented in other specific forms without departing the spirit or basic features of the present application. Therefore, the present embodiments are to be considered as illustrative and not restrictive. The scope of the present application is defined by the appended claims rather than the above-mentioned description, and therefore it is intended that all changes which fall within the meaning and range of equivalency of the claims are embraced in the present application. Any reference signs in the claims should not be construed as limiting the claims involved. In addition, it is apparent that the word “comprising” does not exclude other elements or steps, and the singular does not exclude the plural. The terms first and second and the like are used to represent names and do not represent any particular order.

What is claimed is:

1. A method for performing wireless connection pre-authorization on a user device at a network device, comprising:
determining a target wireless access point to be accessed by the user device of a user according to activity information of the user; and
transmitting device identification information of the user device to a wireless routing device corresponding to the target wireless access point for the wireless routing device to perform wireless connection pre-authorization on the user device.

2. The method according to claim 1, wherein the method further comprising:
determining pre-authorization information for the device identification information of the user device with respect to the wireless routing device corresponding to the target wireless access point;
wherein transmitting device identification information of the user device to a wireless routing device corresponding to the target wireless access point for the wireless routing device to perform wireless connection pre-authorization on the user device comprising:
transmitting the device identification information and the pre-authorization information to the wireless routing device for the wireless routing device to perform wireless connection pre-authorization on the user device.

3. The method according to claim 1, wherein the activity information of the user comprises at least one of:
historic activity information of the user; and
current location information of the user.

4. The method according to claim 1, wherein the activity information of the user comprises historic activity information of the user;
wherein the step of determining a target wireless access point to be accessed by the user device of the user according to activity information of the user comprising:
determining future activity location information of the user according to the historic activity information of the user; and
determining a target wireless access point to be accessed by the user device of the user according to the future activity location information.

5. The method according to claim 4, wherein the step of determining a target wireless access point to be accessed by the user device of the user according to activity information of the user further comprising:
determining future activity location information of the user in a future period of time information according to the historic activity information of the user; and
determining a target wireless access point to be accessed by the user device of the user in the future period of time information according to the future activity location information, wherein the target wireless access point is located from the future activity location information at a distance which is less than or equals to distance threshold information;
wherein the step of transmitting device identification information of the user device to a wireless routing device corresponding to the target wireless access point for the wireless routing device to perform wireless connection pre-authorization on the user device comprising:
transmitting the device identification information of the user device and the future period of time information to the wireless routing device corresponding to the target wireless access point for the wireless routing device to perform wireless connection pre-authorization on the user device.

6. The method according to claim 1, wherein the activity information of the user comprises current location information of the user;
wherein the step of determining a target wireless access point to be accessed by the user device of the user according to activity information of the user comprising:
determining a target wireless access point to be accessed by the user device of the user according to the current location information of the user, wherein the target wireless access point is located from the current location information at a distance which is less than or equals to distance threshold information.

7. A method for performing wireless connection pre-authorization on a user device at a wireless routing device, comprising:
acquiring device identification information of the user device transmitted by a network device; and
performing wireless connection pre-authorization on the device identification information.

8. The method according to claim 7, wherein the method further comprising:
when receiving a connection authentication request transmitted by the user device to a wireless access point corresponding to the wireless routing device, and the device identification information has been pre-authorized wireless connection with respect to the wireless access point, transmitting authentication pass response information to the user device.

9. The method according to claim 8, wherein the method further comprising:
if the device identification information has not been pre-authorized wireless connection with respect to the wireless access point, performing authentication on the connection authentication request and transmitting corresponding authentication result information to the user device.

10. The method according to claim 7, wherein the step of acquiring device identification information of the user device transmitted by a network device comprising:
receiving the device identification information of the user device and pre-authorization information for the device identification information with respect to the wireless routing device transmitted by the network device;
wherein the step of performing wireless connection pre-authorization on the device identification information comprising:
if the pre-authorization information comprises a successful pre-authorization, performing wireless connection pre-authorization on the device identification information.

11. The method according to claim 7, wherein the step of acquiring device identification information of the user device transmitted by a network device comprising:
acquiring the device identification information and corresponding future period of time information of the user device transmitted by the network device;
wherein the step of performing wireless connection pre-authorization on the device identification information comprising:
performing wireless connection pre-authorization on the device identification information based on the future period of time information.

12. The method according to claim 11, wherein the method further comprising:
when receiving a connection authentication request transmitted by the user device to a wireless access point corresponding to the wireless routing device, and the connection authentication request is transmitted within the future period of time information, and the device identification information has been pre-authorized wireless connection with respect to the wireless access point, transmitting authentication pass response information to the user device.

13. A network device for performing wireless connection pre-authorization on a user device, the network device comprising:
a processor; and
a memory configured to store computer executable instructions, wherein the executable instructions, when executed, cause the processor to:
determine a target wireless access point to be accessed by the user device of a user according to activity information of the user; and
transmit device identification information of the user device to a wireless routing device corresponding to the target wireless access point for the wireless routing device to perform wireless connection pre-authorization on the user device.
